(19) United States
(12) Patent Application Publication
(10) Pub. No.: US 2017/0247942 A1
(43) Pub. Date: Aug. 31, 2017

(54) EXTENSIBLE HEADRAIL CAP ASSEMBLY FOR A WINDOW COVERING

(71) Applicant: David R. Hall, Provo, UT (US)

(72) Inventors: David R. Hall, David, UT (US); Austin Carlson, Provo, UT (US); Emily Brimhall, Alpine, UT (US); Jerome Miles, Spanish Fork, UT (US)

(21) Appl. No.: 15/054,757

(22) Filed: Feb. 26, 2016

(51) Int. Cl. E06B 9/323; F16M 13/02; A47H 1/124

(52) U.S. Cl. CPC E06B 9/323; A47H 1/124; F16M 13/02

(57) ABSTRACT

An apparatus for installing a window covering is disclosed. In one embodiment, such an apparatus includes a stationary portion for attachment to an end of a headrail of a window covering, and a moveable portion to contact an inside of a window casing. A threaded member is provided that, when rotated, translates the moveable portion relative to the stationary portion. A manual actuator is provided to rotate the threaded member. In certain embodiments, the actuator is a thumb wheel configured to rotate the threaded member. In other embodiments, the actuator is a lever arm, such as a ratcheting lever arm, configured to rotate the threaded member. A corresponding method is also disclosed and claimed herein.

### BACKGROUND

Field of the Invention

This invention relates to systems and methods for installing window coverings and other window coverings.

Background of the Invention

Window coverings and other similar window coverings are typically installed in windows using mounting brackets that are screwed into the upper corners of window casings. Although effective, this installation technique may require a user to make measurements to ensure that the brackets are installed in the correct locations, as well as require tools (e.g., drills, screwdrivers, etc.) to drive the screws into the window casing. Unfortunately, this installation technique may leave unsightly holes in the window casing and potentially damage the paint or finish thereon. This installation technique can also be quite time consuming. In a home or building containing many windows to be outfitted with window coverings or other window coverings, the installation time may increase accordingly.

In order to reduce the amount of time and/or effort needed to install window coverings, installation techniques have been developed. One such technique involves placing spring-loaded mounting brackets at the end of a window covering headrail. When the window covering headrail is placed into a window casing, the spring-loaded mounting brackets are released to provide a compression fit between the window covering and the window casing. Unfortunately, in some cases, such springs may generate insufficient force to secure the window covering to the window casing, particularly with long or heavy window coverings. This can result in movement or creep of the window covering relative to the window casing.

In view of the foregoing, what is needed are improved systems and methods to securely install window coverings in window casings. Ideally such systems and methods will eliminate and/or reduce the need for tools when installing window coverings. Such systems and methods will also ideally eliminate and/or reduce the need for screws or other fasteners when installing window coverings.

### SUMMARY

This invention has been developed in response to the present state of the art and, in particular, in response to the problems and needs in the art have not yet been fully solved by currently available systems and methods. Accordingly, improved systems and methods have been deployed to install window coverings. Features and advantages of different embodiments of the invention will become more fully apparent from the following description and appended claims, or may be learned by practice of the invention as set forth hereinafter.

Consistent with the foregoing, an extensible headrail cap assembly for installing a window covering is disclosed. In one embodiment, a stationary portion for attachment to an end of a headrail of a window covering, and a moveable portion to contact an inside of a window casing is disclosed. A threaded member is provided that, when rotated, translates the moveable portion relative to the stationary portion. A manual actuator is provided to rotate the threaded member. In certain embodiments, the actuator is a thumb wheel configured to rotate the threaded member. In other embodiments, the actuator is a lever arm, such as a ratcheting lever arm, configured to rotate the threaded member. A corresponding method for installation of a window covering is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a perspective view of one embodiment of a window covering installed using an extensible end cap assembly in accordance with the invention.

FIG. 2 is a perspective view showing a thumb-wheel-style extensible end cap assembly installed in a window covering.

FIG. 3 is a perspective view showing the thumb-wheel-style extensible end cap assembly and a fixed-length end cap assembly in the ends of a headrail;

FIG. 4 is a close-up perspective view showing an underside of the thumb-wheel-style extensible end cap assembly;

FIG. 5 is a cross-sectional view showing internal working of the thumb-wheel-style extensible end cap assembly.

FIGS. 6A through 6C show various views of the fixed-length end cap assembly.

FIGS. 7A and 7B show various views of the stationary portion of the thumb-wheel-style extensible end cap assembly.

FIGS. 8A and 8B show various embodiments of the movable portion of the thumb-wheel-style extensible end cap assembly.

FIGS. 9A through 9C show various views of a thumb wheel for use with the thumb-wheel-style extensible end cap assembly.

FIGS. 10A and 10B show several views of a mounting bracket for attaching the thumb-wheel-style extensible end cap assembly to a window casing.

FIG. 11 is a perspective view of a headrail having a ratcheting-style extensible end cap assembly installed in an end thereof.

FIGS. 12A and 12B are cross-sectional views showing internal workings of the ratcheting-style extensible end cap assembly.

FIG. 13 is a perspective view of a rear side of the ratcheting-style extensible end cap assembly.

FIG. 14A is a cross-sectional view showing internal operation of the ratcheting-style extensible end cap assembly.

FIG. 14B is a perspective view of a ratcheting lever arm of the ratcheting-style extensible end cap assembly.

FIGS. 15A and 15B show several views of the moveable portion of the ratcheting-style extensible end cap assembly.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the indention. The presently described embodiments will be best understood by reference to the drawings, wherein like parts are designated by like numerals throughout.

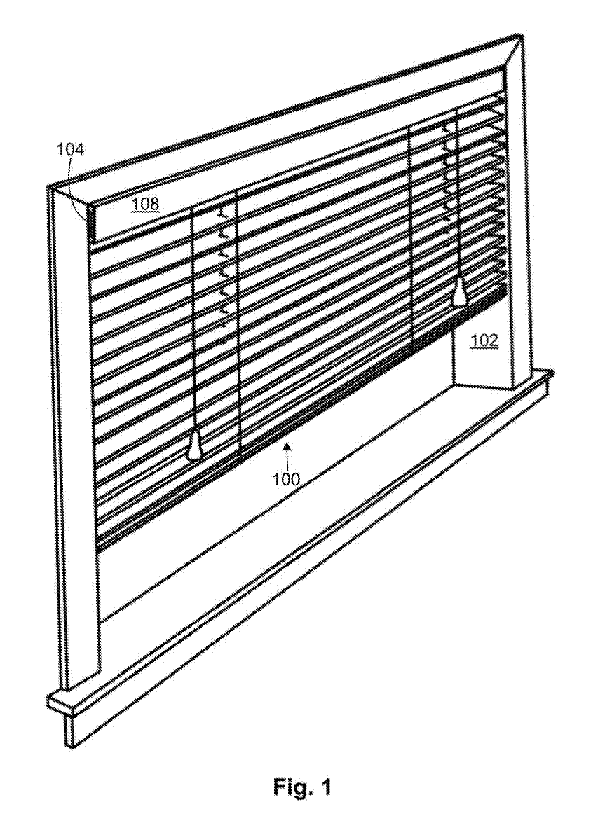

Referring to FIG. 1, a perspective view showing one embodiment of a window covering 100 installed using an extensible end cap assembly 104 accordance with the invention is illustrated. As shown, the extensible end cap assembly 104 is coupled to an end of a headrail 108 of the window covering 100. The extensible end cap assembly 104 is configured to retain the window covering 100 within a window casing 102 by creating a compression fit between the headrail 108 and the window casing 102. That is, the extensible end can assembly 104 is configured to extend relative to an end of the headrail 108 to create compression against the inside of the window casing 102, thereby retaining the window covering 100 within the window casing 102.

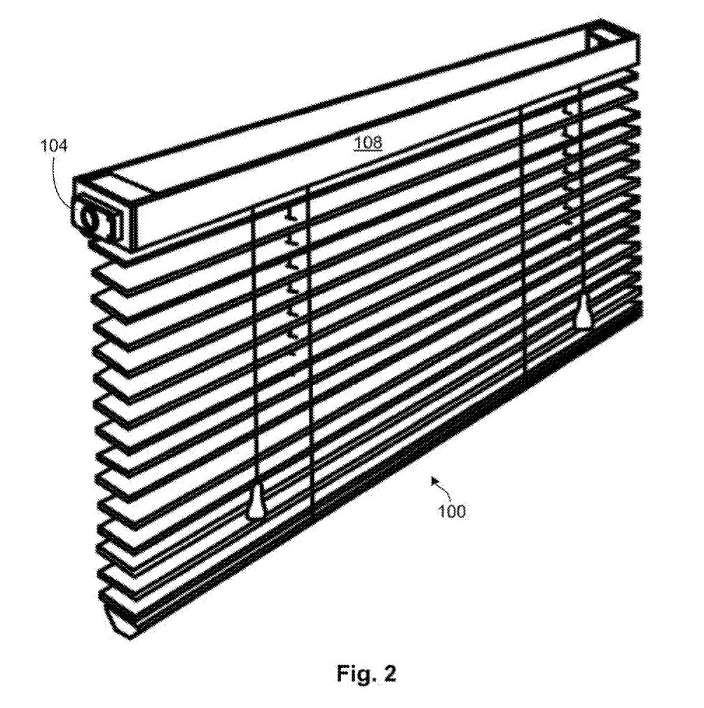

FIG. 2 shows the window covering 100 removed from the window casing 102, with the extensible end cap assembly 104 installed in an end thereof. As shown, the extensible end cap assembly 104 may, in certain embodiments, slide into an end of the headrail 108. In other embodiments, the extensible end can assembly 104 slides over the end of the headrail 108, such as in cases where the end of the headrail is closed. The extensible end cap assembly 104 may be sized to fit snugly within the headrail 108. The extensible end cap assembly 104 may also be provided in different sizes to accommodate headrails 108 of different dimensions. In other embodiments, the extensible end cap assembly 104 may include different adapters to fit different sizes of headrails 108, thereby allowing a uniform-sized extensible end cap assembly 104 to be installed in different size headrails 108.

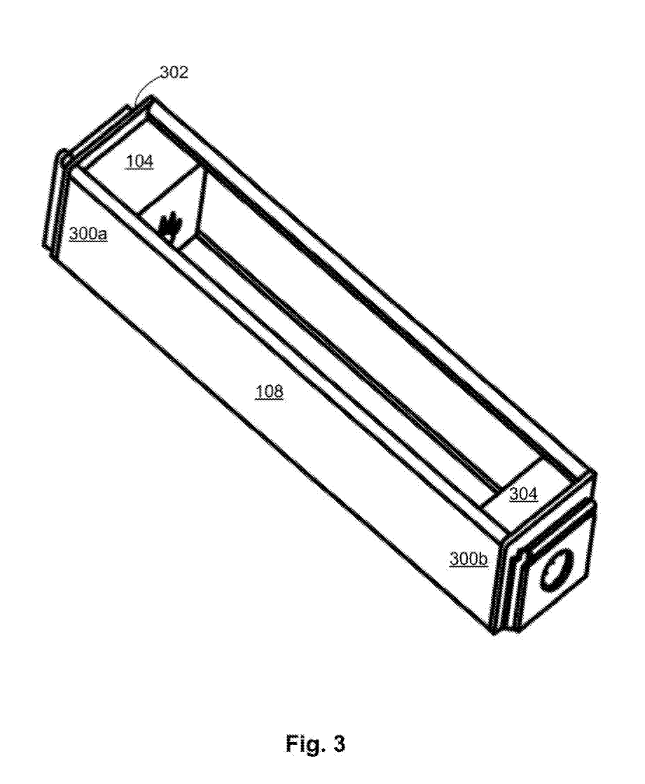

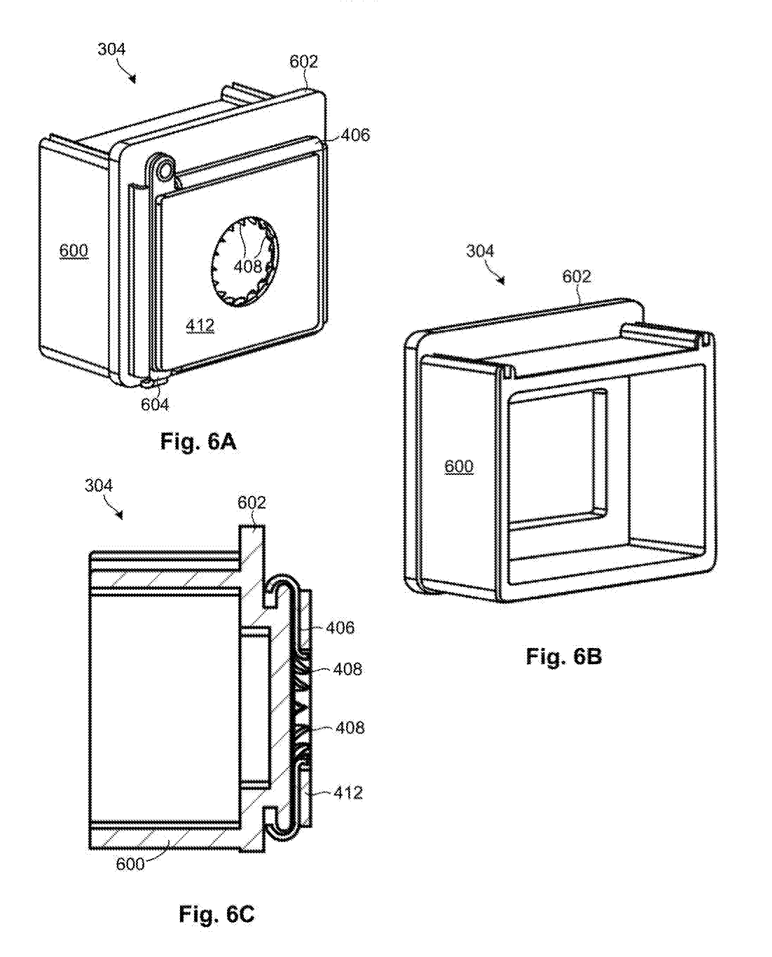

FIG. 3 shows one embodiment of extensible end cap assembly 104, in this case a thumb-wheel-style extensible end cap assembly 104, installed in a window covering headrail 108. A view from the top of the headrail 108 is provided. In this embodiment, the extensible end cap assembly 104 slides into a first end 300a of the headrail 108 and is configured to extend relative to the first end 300a to create a compression fit between the headrail 108 and a window casing 102. A lip 302 on the extensible end cap assembly 104 pushes against the end 300a of the headrail 108 and prevents the extensible end cap assembly 104 from sliding too far into the headrail 108. At the other end 300b of the headrail 108, a fixed-length end cap assembly 304 may be provided to contact the other side of the window casing 102. Various views of the fixed-length end cap assembly 304 are shown in FIGS. 6A through 6C.

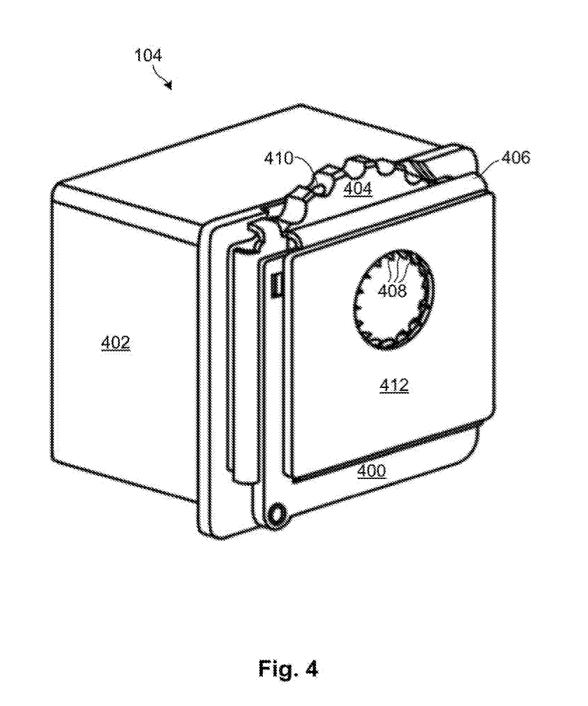

FIG. 4 shows a close-up perspective view of the underside of the thumb-wheel-style extensible end cap assembly 104. As shown, the thumb-wheel-style extensible end cap assembly 104 includes a stationary portion 402 and a moveable portion 400. The stationary portion 402 may be used to an end of the headrail 108. The moveable portion 400 may extend from the stationary portion 402 to contact a window casing 102. A threaded member (not shown) may translate the moveable portion 400 relative to the stationary portion 402. In the illustrated embodiment, a thumb wheel 404 is used to turn the threaded member and thereby translate the moveable portion 400 relative to the stationary portion 402. This thumb wheel 404 may be turned by a thumb or a finger. The thumb wheel 404 may also, in certain embodiments, be turned by a tool (e.g., rod, screwdriver, etc.) inserted into the thumb wheel 404. For example, the thumb wheel 404 may include one or more apertures 410 into which a tool may be inserted and used to turn the thumb wheel 404. This feature may provide additional leverage to turn the thumb wheel 404 and/or increase ease of operation.

As shown in FIG. 4, the moveable portion 400 may, in certain embodiments, include a mounting bracket 406 that allows the window covering 100 to be removed and reinstalled after its initial installation. A corresponding mounting bracket 406 may be provided on the fixed-length end cap assembly 304 previously discussed. The mounting bracket 406 may, in certain embodiments, be coated with an adhesive 412. When installing a window covering 100 in a window casing 102, the mounting bracket 400 may be adhered to the window casing 102 at a desired location. The thumb wheel 404 may then be turned to create a compression fit between the window covering 100 and the window casing 102. This will press the adhesive 412 against the window casing 102 to improve the bond therebetween.

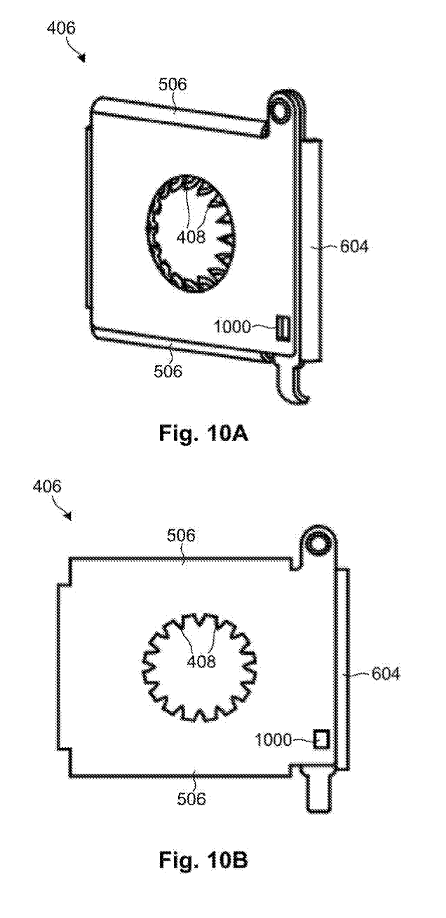

In certain embodiments, the mounting bracket 406 may also be designed with one or more spikes 408, barbs 408, cleats 408, or the like, to penetrate the window casing 102 as compression increases between the extensible end cap assembly 104 and the window casing 102. The adhesive 412 in combination with the spikes 408, barbs 408, or cleats 408 may improve the bond with the window casing 102. Once the mounting bracket 406 is attached to the window casing 102, the window covering 100 (along with the remaining portion of the extensible end cap assembly 104) may be removed from the window casing 102 by simply sliding the window covering 100 out of the mounting brackets 406. The mounting brackets 406 may stay in place on the window casing 102. The window covering 100 may be reinstalled by simply sliding the window covering 100 back into the mounting brackets 406. One example of a mounting bracket 406 for use with the extensible end cap assembly 104 and fixed-length end cap assembly 304 is shown in FIGS. 10A and 10B.

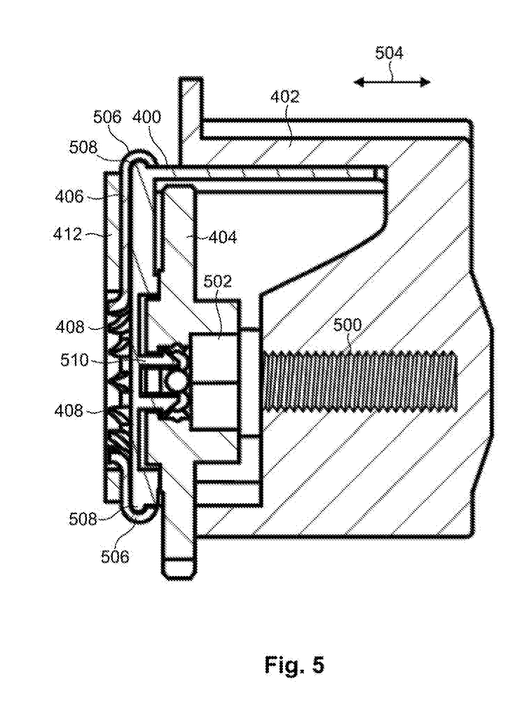

FIG. 5 is a cross-sectional view showing internal workings of the thumb-wheel-style extensible end cap assembly 104 of FIG. 4. The stationary portion 402 and a moveable portion 400 are shown, with the moveable portion 400 moving in a direction 504 relative to the stationary portion 402. Rotation of a threaded member 500 translates the moveable portion 400 relative to the stationary portion 402. A thumb wheel 404 is used to manually turn the threaded member 500. In the illustrated embodiment, the thumb wheel 404 rotates around a spindle 510 (embodied as a pair of clips) incorporated into the moveable portion 400, and engages the threaded member 500 using a key 502, such as a hex-shape key 502. In the illustrated embodiment, the thumb wheel 404 is exposed at a bottom of the thumb-wheel-style extensible end cap assembly 104, although it could also be exposed at a side of the thumb-wheel-style extensible end cap assembly 104 or at some other location.

As further shown, the thumb-wheel-style extensible end cap assembly 104 includes a mounting bracket 406 that enables the window covering 100 to be removed and reinstalled after its initial installation. In the illustrated embodiment, the mounting bracket 406 include curved ends 500 that provide a track for sliding the thumb-wheel-style extensible end cap assembly 104 into and out of the mounting bracket 406. Ridges 508 on the moveable portion 400 of the thumb-wheel-style extensible end cap assembly 104 may be configured to slide in this track. As further shown, the mounting bracket 406 may be coated with an adhesive 412 to adhere the mourning bracket 406 to a window casing 102. The mounting bracket 406 is also configured with one or more spikes 408, barbs 408, cleats 408, or the like, to penetrate the window casing 102 and prevent slippage between the window casing 102 and the thumb-wheel-style extensible end cap assembly 104.

Referring to FIGS. 6A through 6C, various views of a fixed-length end cap assembly 304 are illustrated. FIGS. 6A and 6B are perspective views of the front and back of the fixed-length end cap assembly 304, respectively. FIG. 6C is a cross-sectional view of the fixed-length end cap assembly 304. As shown, the fixed-length end cap assembly 304 includes and insert portion 600 to slide into the end of a headrail 108. A lip 602 on the fixed-length end cap assembly 304 pushes against the end of the headrail 108 and keeps the fixed-length end cap assembly 304 at a consistent position relative to the end of the headrail 108. As further shown, fixed-length end cap assembly 304 includes a mounting bracket 406 that allows the window covering 100 to be removed and reinstalled after its initial installation. A folding arm 604, incorporated into the mounting bracket 406, may be used to retain the window covering 100 in the mounting bracket 406. As further shown, the mounting bracket 406 is coated with an adhesive 412 and is configured with one or more spikes 408, barbs 408, or cleats 408 to penetrate the window casing 102 when installing the window covering 100.

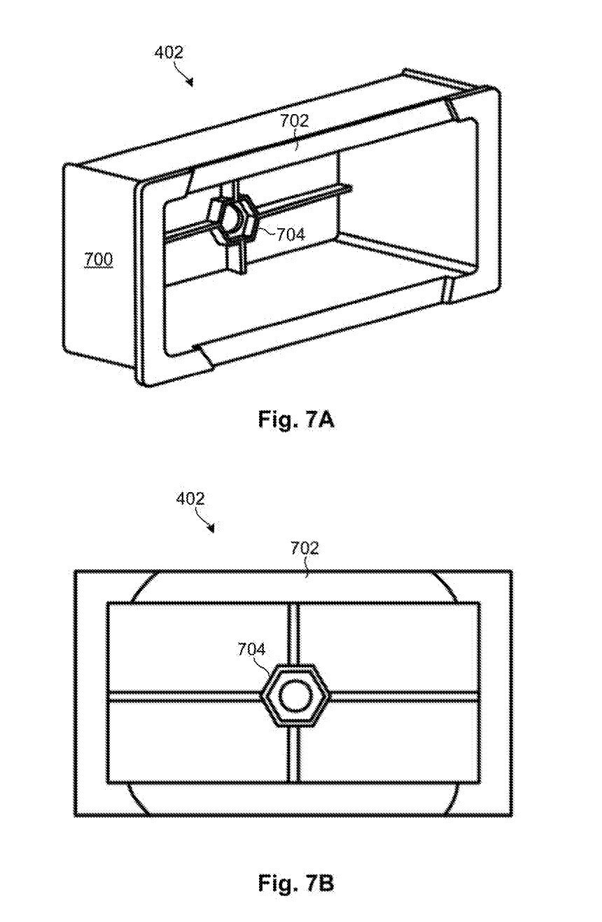

Referring to FIGS. 7A and 7B, several views of the stationary portion 402 of the thumb-wheel-style extensible end cap assembly 104 are shown (Note: the stationary portion 402 illustrated in FIGS. 7A and 7B is a narrower version of the stationary portion 402 illustrated in the previous Figures and is configured to fit in a narrower headrail 108; however, the function remains the same.) As shown, the stationary portion 402 includes an insert portion 700 configured to slide into an end of a headrail 108, and a lip 702 configured to keep the stationary portion 402 at a consistent position relative to the end of the headrail 108. The stationary portion 402 further incorporates an internally threaded member 704 configured to receive the externally threaded member 500 previously disclosed. As the externally threaded member 500 is rotated, the externally threaded member 500 may push against the stationary portion 402 to create a compression fit between the headrail 108 and a window casing 102.

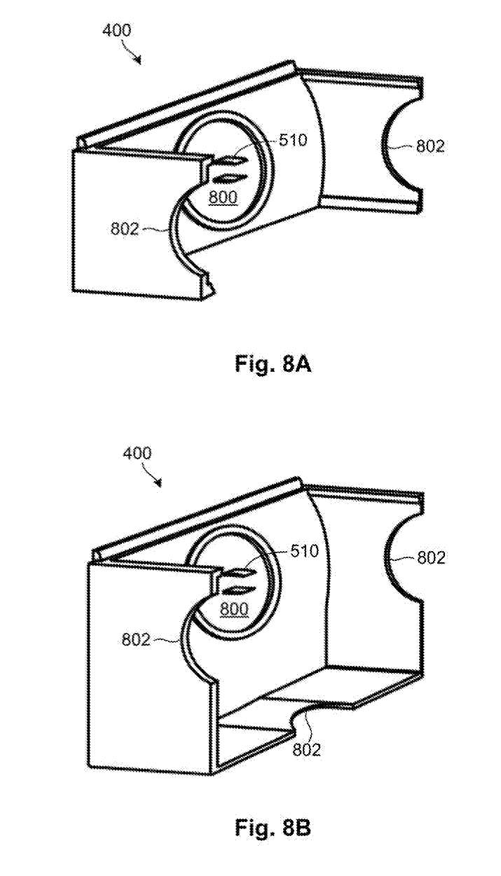

Referring to FIGS. 8A and 8B, one embodiment of a moveable portion 400 of thumb-wheel-style extensible cap assembly 104 is illustrated. FIG. 8A shows one embodiment of a moveable portion 400 for an extensible end cap assembly 104 configured to fit a narrower headrail 108. FIG. 8B shows one embodiment of a moveable portion 400 for an extensible end cap assembly 104 configured to fit a wider headrail 108. As shown in both embodiments, the moveable portion 400 includes a circular recess 800 to accommodate the thumb wheel 404. A hub of the thumb wheel 404 may rotate within the circular recess 800 and the circular recess 800 may keep the thumb wheel 404 confined to a certain axis of rotation. A pair of clips 510 may retain the thumb wheel 404 within the circular recess 800 as well as provide a spindle 510 around which the thumb wheel 404 may rotate. In certain embodiments, cutouts 802 may be provided in the moveable portion 400 that enable the moveable portion 400 to slide freely within the stationary portion 402 while avoiding support members such as gussets, ribbing, or other structural support members in the stationary portion 402.

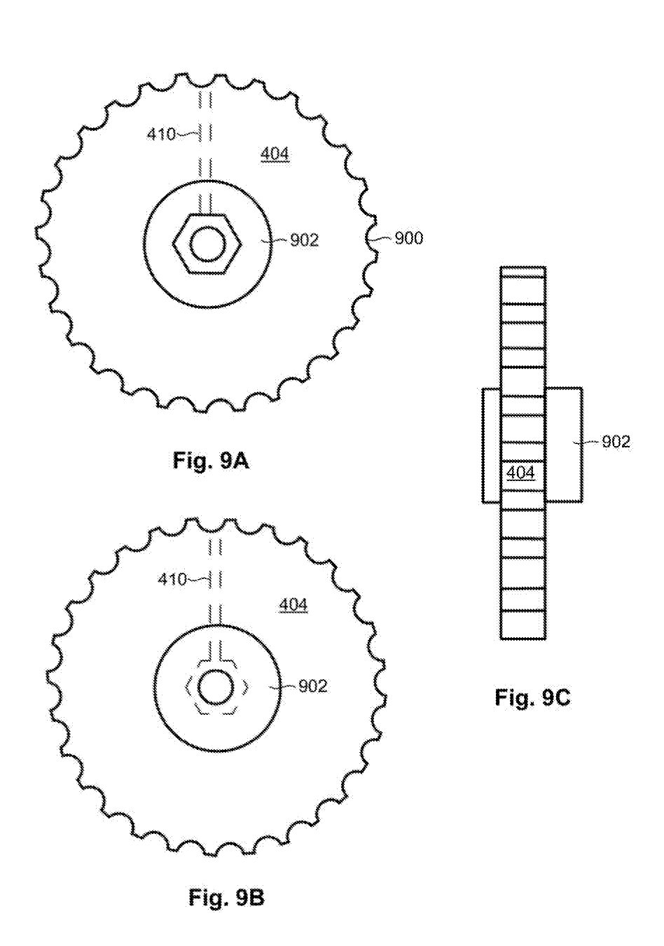

Referring to FIGS. 9A through 9C, several different views of a thumb wheel 404 for use with a thumb-wheel-style extensible end cap assembly 104 in accordance with the invention are provided. As shown, the thumb wheel 404 is designed with indentations 900 around a circumference thereof to provide grip to a thumb or finger. The thumb wheel 404 may also be designed with one or more apertures 410 to accommodate a tool such as a rod or end of a screwdriver. Such a tool may provide additional leverage to turn the thumb wheel 404.

As further shown, the thumb wheel 404 includes a circular hub 902. This circular hub 902 may rotate within the circular recess 800 previously discussed in associated with FIGS. 8A and 8B. The circular hub 902 may, in certain embodiments, be designed with a key 502, such as a hex-shaped key 502, to interlock with a corresponding shape on the externally threaded member 500.

Referring to FIGS. 10A and 10B, several views of a mounting bracket 406 in accordance with the invention are illustrated. As previously explained, the mounting bracket 406 may be designed to provide a secure mount between the window covering 100 and a window casing 102. This may be accomplished using an adhesive on the mounting bracket 400 as well as one more spikes 408, barbs 408, or cleats 408 that are designed to penetrate the window casing 102. The length of the spikes 408, barbs 408, or cleats 408 may be designed for different window casing materials. For example, a wood window casing 102 may require less penetration whereas a drywall or plaster window casing 102 may require additional penetration to provide a secure mount. In certain embodiments, the spikes 408, barbs 408, or cleats 408 are designed with sufficient length to provide a secure mount in softer or less sound materials such as drywall or plaster. The spikes 408, baths 408, or cleats 408 may also, in certain embodiments, be removable of bendable for applications where the window casing 102 cannot be easily penetrated, such as for metal or concrete window casings 102.

As shown, the spikes 408, barbs 408, or cleats 408 are provided in a circular configuration on the mounting bracket 406, although other patterns are also possible. The illustrated configuration allows the mounting bracket 406 and associated spikes 408, barbs 408, or cleats 408 to be fabricated from stamped sheet metal, although other materials and fabrication techniques may also be used. As further shown in FIGS. 10A and 10B, the mounting bracket 406 may include curved sides 506 that provide a track for sliding the window covering 100 into and out of the mounting bracket 406. A folding arm 604, incorporated into the mounting bracket 406 and clipping or snapping into plane at location 1000, may be used to retain the window covering 100 the mounting bracket 406.

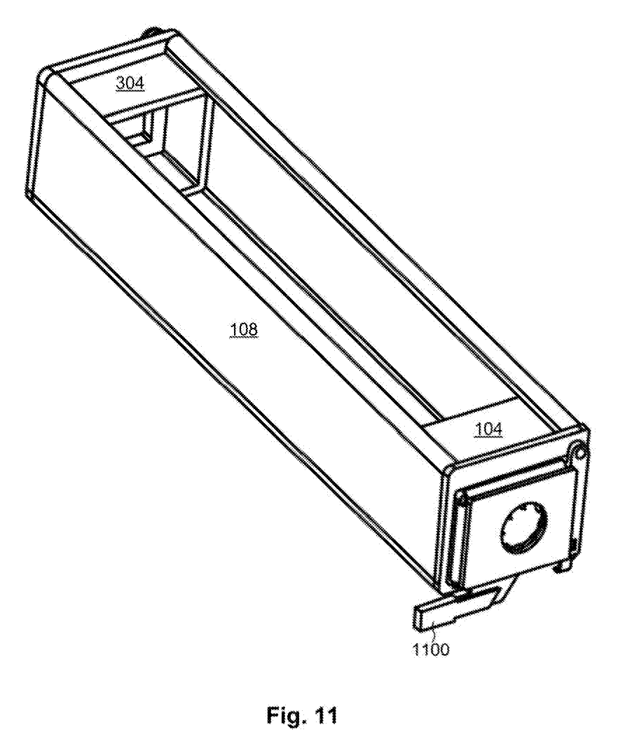

Referring to FIG. 11, another embodiment of an extensible end cap assembly 104 in accordance with the invention is illustrated. In this embodiment, the extensible end cap assembly 104 is a ratcheting-style extensible end cap assembly 104. In general, the ratcheting-style ostensible end cap assembly 104 uses a ratcheting lever arm 1100 as opposed to a thumb wheel 404 to turn the threaded member 500 previously discussed.

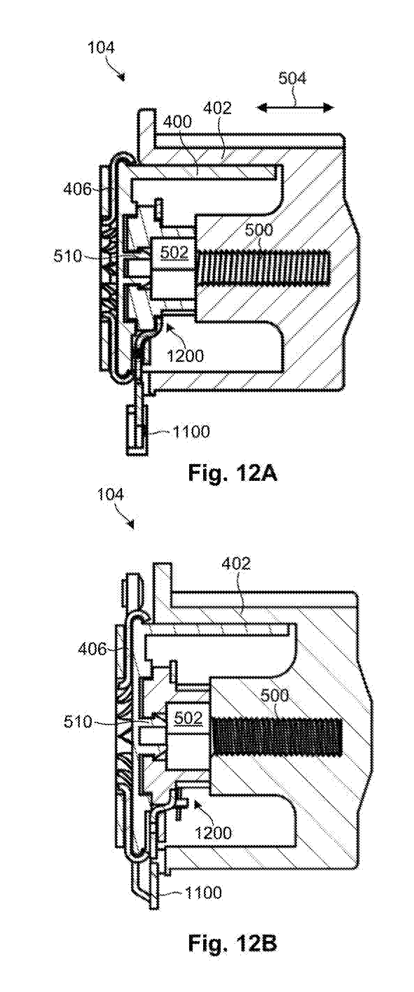

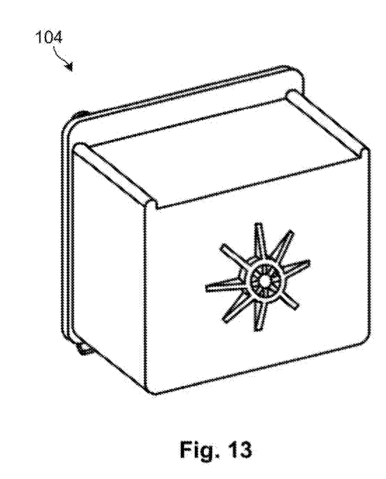

FIGS. 12A and 12B show cross-sectional side views of the ratcheting-style extensible end cap assembly 104 from opposite sides. As shown, the ratcheting-style extensible end cap assembly 104 includes a stationary portion 402 and moveable portion 400, like the previously-described thumb-wheel-style extensible end cap assembly 104. Unlike the thumb-wheel-style extensible end cap assembly 104, the ratcheting-style extensible end cap assembly 104 includes a ratcheting lever arm 1100 and ratcheting mechanism 1200. The ratcheting lever arm 1100 is coupled to the ratcheting mechanism 1200 in order to turn the externally threaded member 500. When rotated in a first direction, the ratcheting lever arm 1100 will turn the externally threaded member 500. However, when rotated in the opposite direction, the ratcheting lever arm 1100 will not turn the externally threaded member 500. The ratcheting mechanism 1200 may be configured to enable reversal of the ratcheting action, thereby allowing the externally threaded member 500 to be rotated in the opposite direction. FIG. 13 shows a rear perspective view of the ratcheting-style extensible end cap assembly 104.

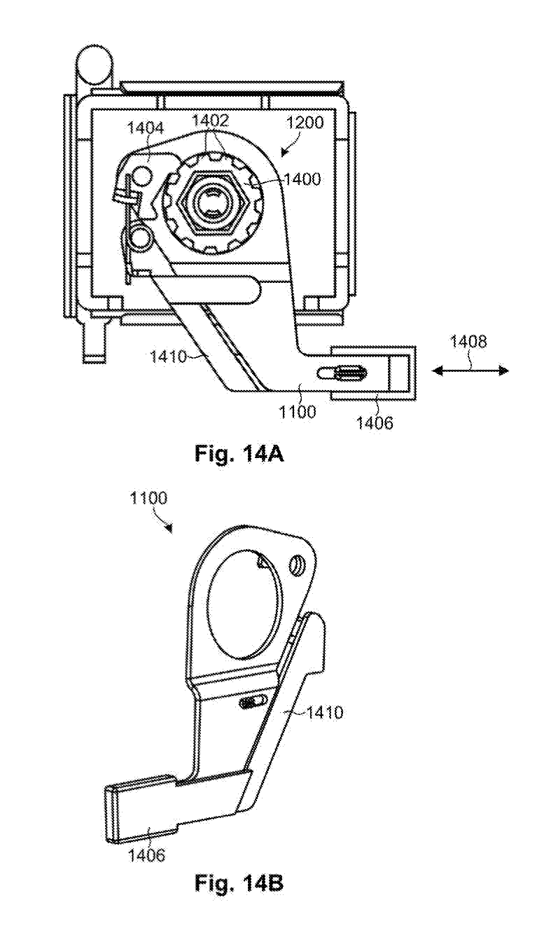

FIG. 14A shows a cutaway front view of the ratcheting-style extensible end cap assembly 104, particularly showing its internal workings. As shown, the ratcheting-style extensible end cap assembly 104 includes a ratcheting lever arm 1100 and ratcheting mechanism 1200 to rotate the externally threaded member 500. As shown, the ratcheting mechanism 1200 includes a gear 1400, having teeth 1402, and a pawl 1404 to engage the teeth 1402. When rotating the ratcheting lever arm 1100 in a first direction, the pawl 1404 may engage the teeth 1402 to turn the externally threaded member 500 in the first direction. Whets rotating the ratcheting loser arm 1100 in a second direction, the pawl 1404 will slip over the teeth 1402, thereby not rotating the externally threaded member 500 in the second direction.

The position of the pass 1404 may be reversed to provide a reserve ratcheting action. That is, when the position of the pawl 1404 is reversed, rotating the ratcheting lever arm 1100 in the first direction will not cause the externally threaded member 500 to rotate, whereas rotating the ratcheting lever arm 1100 in the second direction will cause the extremely threaded member 500 to rotate in the second direction. In certain embodiments, the ratcheting lever arm 1100 may be outfitted with a mechanism to reverse the petition of the pawl 1404. For example, a slidable handle 1406 on the ratcheting lever arm 1100 may be slid in a direction 1408 to toggle the position of the pawl 1404. A mechanical linkage 1410, coupled to the slidable handle 1406, may mechanically toggle the pawl 1404. A user may switch the ratcheting action by a moving the slidable handle 1406. FIG. 14B is a perspective view of the other side of the ratcheting lever arm 1100 and mechanical linkage 1410.

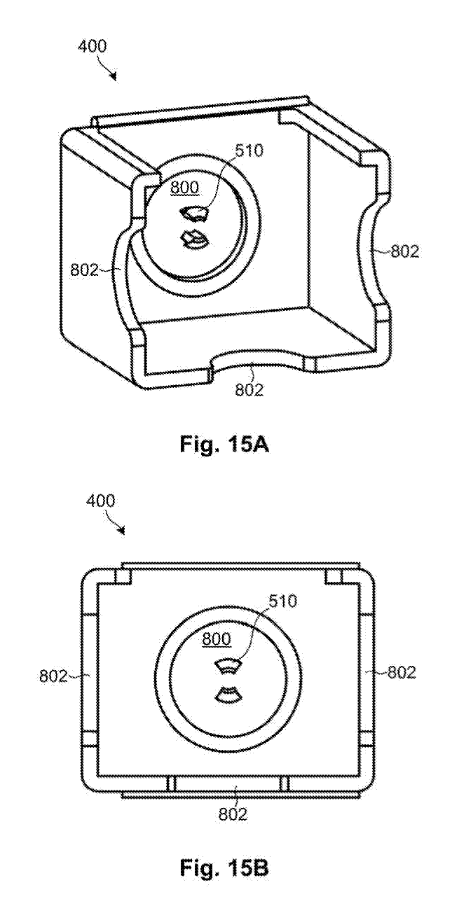

Referring to FIG. 15A and 15B, the moveable portion 400 of the ratcheting-style extensible end cap assembly 104 is illustrated. As shown, the moveable portion 400 includes circular recess 800 to accommodate the ratcheting mechanism 1200. The ratcheting mechanism 1200 may rotate within the circular recess 800 and the circular recess 800 may keep the ratcheting mechanism 1200 confined to a desired axis of rotation. A pair of clips 510 may retain the ratcheting mechanism 1200 within the circular recess 800 as well as provide a spindle 510 around which the ratcheting mechanism 1200 may rotate. In certain embodiments, cutouts 802 may be provided in the moveable portion 400 to enable the moveable portion 400 to slide freely within the stationary portion 402 while avoiding support members such as gussets, ribbing, or other structural support members in the stationary portion 402.

In the drawings and associated description, two types of actuators have been described for the extensible end cap assembly 104, namely a thumb wheel 404 and a ratcheting lever arm 1100. These actuators have been presented by way of example and not limitation. Other types of actuators may also be used to extend the extensible end cap assembly 104. For example, in an alternative embodiment, an electric motor may be incorporated into the extensible end cap assembly 104 to turn the externally threaded member 500 either directly or with the aid of a gearbox. In other embodiments, hydraulic or pneumatic rams or expandable devices may be used to extend the extensible end cap assembly 104 relative to an end of a headrail 108 and thereby retain a window covering 100 in a window casing 102. In yet other embodiments, a linear ratcheting mechanism may be used to extend the extensible end cap assembly 104. For example, a rack-and-pinion type mechanism or similar ratcheting-jack-type mechanisms may be used to extend the extensible end cap assembly 104 relative to an end of a headrail 108. Thus, other means for extending the extensible end cap assembly 104 relative to an end of a headrail 108 are possible and within the scope of the invention.

The systems and methods disclosed herein may be embodied in other specific forms without departing from their spirit or essential characteristics. The described embodiments are to be considered at all respects only as illustrative and not restrictive. The scope of the invention, therefore, indicated by the appended claims rather than by the foregoing description. All changes which come within the meaning and range of equivalency of the claims are to be embraced within their scope.

1. An apparatus for installing a window covering comprising:
a stationary portion for attachment to an end of a headrail of the window covering;
a moveable portion to contact an inside of a window casing;
a threaded member to, upon rotation, translate the moveable portion relative to the stationary portion; and
an actuator to rotate the threaded member, wherein when the actuator is rotated the threaded member pushes against the stationary portion to create a compression fit between the headrail and the window casing.

2. The apparatus of claim 1, wherein the actuator is a thumb wheel.

3. The apparatus of claim 2, wherein the thumb wheel includes an aperture on a circumference thereof for insertion of a tool.

4. The apparatus of claim 1, wherein the actuator is a lever arm.

5. The apparatus of claim 4, wherein the lever arm is a ratcheting lever arm.

6. The apparatus of claim 5, wherein the ratcheting lever arm includes functionality to enable reversal of a ratcheting mechanism.

7. The apparatus of claim 1, wherein the moveable portion includes a mounting bracket to enable mounting of the window covering to the inside of the window casing.

8. The apparatus of claim 7, wherein the mounting bracket comprises at least one of spikes, barbs, and cleats.

9. The apparatus of claim 7, wherein the mounting bracket is configured to remain in place on the window casing after removal of the window covering.

10. The apparatus of claim 9, wherein the moveable portion slides into and out of the mounting bracket.

11. A method for installing a window covering, the method comprising:
providing a stationary portion for attachment to an end of a headrail of the window covering;
contacting an inside of a window ending with a moveable portion;
rotating a threaded member in order to translate the moveable portion relative to the stationary portion; and
providing an actuator to rotate the threaded member, wherein when the actuator is engaged the threaded member pushes against the stationary portion to create a compression fit between the headrail and the window casing.

12. The method of claim 11, wherein the actuator is a thumb wheel and engaging the actuator comprises turning the thumb wheel.

13. The method of claim 12, wherein turning the thumb wheel comprises using a tool inserted into an aperture on the thumb wheel.

14. The method of claim 11, wherein the actuator is a lever arm and engaging the actuator comprises exerting torque on the lever arm.

15. The method of claim 14, wherein the lever arm is a ratcheting lever arm.

16. The method of claim 15, further comprising using functionality on the ratcheting lever arm to reverse a ratcheting mechanism.

17. The method of claim 11, wherein the moveable port ion includes a mounting bracket to enable mounting of the window covering to the inside of the window casing.

18. The method of claim 17, wherein the moveable portion presses at least one of spikes, barbs, and cleats, incorporated into the mounting bracket into the window casing.

19. The method of claim 17, wherein the mounting bracket is configured to remain in place on the window casing after removal of the window covering.

20. The method of claim 19, further comprising removing the window covering by sliding the moveable portion out of the mounting bracket.
